(19) United States
(12) Patent Application Publication
(10) Pub. No.: US 2026/0065619 A1
(43) Pub. Date: Mar. 5, 2026

(54) MULTI-MODAL COMPOUND EYE PERCEPTION METHOD AND DEVICE FOR COMPLEX DEGRADED ENVIRONMENT

(71) Applicant: Tongji University, Shanghai (CN)

(72) Inventors: Bin He, Shanghai (CN); Gang Li, Shanghai (CN); Jie Chen, Shanghai (CN); Yonggui Wang, Shanghai (CN); Zhongpan Zhu, Shanghai (CN)

(21) Appl. No.: 19/026,674

(22) Filed: Jan. 17, 2025

(30) Foreign Application Priority Data
Aug. 29, 2024 (CN) 202411201846.1

(51) Int. Cl. G06V 10/143; G06V 10/10; G06V 10/24; G06V 10/25; G06V 10/75; G06V 10/77; G06V 10/774; G06V 10/776; G06V 10/80; G06V 10/82

(52) U.S. Cl. CPC G06V 10/143; G06V 10/16; G06V 10/24; G06V 10/25; G06V 10/751; G06V 10/7715; G06V 10/774; G06V 10/776; G06V 10/806; G06V 10/82

(57) ABSTRACT

A multi-modal compound eye perception method and device for a complex degraded environment includes: acquiring multiple sets of images in the complex degraded environment through a multi-modal compound eye acquisition device, inputting them into a trained feature point prediction model to extract key feature point information of visible light images and infrared images; generating a visible light stitched image and an infrared stitched image based on a nearest neighbor matching technique, the key feature point information of visible light images and the infrared images, and inputting them into a constructed multi-modal perception detection network to perform target detection to obtain a multi-modal perception detection result.

### CROSS REFERENCE TO RELATED APPLICATIONS

The present disclosure claims the priority to the Chinese patent application with the application number 2024112018461, entitled “MULTI-MODAL COMPOUND EYE PERCEPTION METHOD AND DEVICE FOR COMPLEX DEGRADED ENVIRONMENT” and filed on Aug. 29, 2024 with the Chinese Patent Office, the contents of which are incorporated in the present disclosure by reference in their entirety.

### TECHNICAL FIELD

The present disclosure relates to the field of computer vision technology, and in particular to a multi-modal compound eye perception method and device for a complex degraded environment.

### BACKGROUND ART

With the continuous development of science and technology and the progress of society, computer vision technology plays an increasingly important role in various fields. Especially in perception and recognition tasks in a complex degraded environment, traditional visual algorithms face many challenges. For example, in the fields of security monitoring, military reconnaissance, and environmental monitoring, etc., due to the influence of facts of limited viewing angles and a complex degraded environment such as lighting conditions, weather changes, target surface characteristics, etc., traditional visual perception methods often fail to meet actual needs, resulting in low accuracy and robustness in target detection and recognition.

Current researches on compound eye perception are limited to a single visible light modality, and is unable to cope with perception tasks in a complex degraded environment with weak light, dim light, or even no light. Most researches on compound eye feature point prediction use methods based on manually designed features, such as SIFT (Scale-Invariant Feature Transform), SURF (Speeded Up Robust Features), and Harris corner detection. However, these methods are overly sensitive to scene changes such as changes in illumination, scale, and viewing angle, and have difficulty in processing large-scale data and high-dimensional features. At the same time, existing deep learning-based target detection methods have the problem of high computational complexity in the application process of multi-modal stitched images, and are not suitable for image target detection tasks of multi-modal compound eyes.

### SUMMARY

In order to solve the technical problems in the prior art that the traditional visual perception method often cannot meet the actual needs and thus has low accuracy and robustness of target detection and recognition due to the influence of factors of limited viewing angles and a complex degraded environment such as lighting conditions, weather changes, target surface characteristics, etc. Embodiments of the present disclosure provides a multi-modal compound eye perception method and device for a complex degraded environment. The technical solution is as follows.

In an aspect, a multi-modal compound eye perception method for a complex degraded environment is provided, the method being implemented by a multi-modal compound eye perception device, the method including:
S1. acquiring multiple sets of images in the complex degraded environment through a multi-modal compound eye acquisition device, where each set of images in the multiple sets of images include a visible light image and an infrared image;
S2. inputting the multiple sets of images into a trained feature point prediction model to extract key feature point information in the visible light images and key feature point information in the infrared images;
S3. generating a visible light stitched image and an infrared stitched image according to a nearest neighbor matching technique, the key feature point information in the visible light images, and the key feature point information in the infrared images;
S4. inputting the visible light stitched image and the infrared stitched image into a constructed multi-modal perception detection network to perform target detection to obtain a multi-modal perception detection result.

Optionally, the training process of the feature point prediction model in S2 includes:
S21. acquiring a visible light sample image;
S22. performing three convolution operations on the visible light sample image to obtain a first convolution feature map, a second convolution feature map, and a third convolution feature map, respectively;
S23. performing a deconvolution operation on the first convolution feature map, the second convolution feature map, and the third convolution feature map respectively, to obtain a first deconvolution image, a second deconvolution image, and a third deconvolution image;
S24. performing feature fusion on the first deconvolution image, the second deconvolution image, and the third deconvolution image to obtain a fused feature map;
S25. inputting the fused feature map into a maximum pooling layer to obtain a maximum pooling layer output;
S26. inputting the maximum pooling layer output into a bilinear interpolation layer to obtain a bilinear interpolation layer output;
S27. inputting the bilinear interpolation layer output into a fully connected layer to obtain the key feature point information in the visible light sample image; and
S28. training the feature point prediction model according to the key feature point information in the visible light sample image to obtain a trained feature point prediction model.

Optionally, the generating the visible light stitched image and the infrared stitched image according to the nearest neighbor matching technique, the key feature point information in the visible light images and the key feature point information in the infrared images in S3 includes:
S31. acquiring feature points of adjacent visible light images, and matching the acquired feature points by using the nearest neighbor matching technique to obtain a plurality of matched visible light image feature points;
S32. acquiring feature points of adjacent infrared images, and matching the acquired feature points by using the nearest neighbor matching technique to obtain a plurality of matched infrared image feature points;
S33. establishing a constraint condition according to the plurality of matched visible light image feature points;
S34. performing homography transformation alignment on the visible light images and the infrared images respectively according to the constraint condition, the multiple matched visible light image feature points and the multiple matched infrared image feature points, to obtain aligned visible light images and aligned infrared images; and
S35. stitching the aligned visible light images and the aligned infrared images respectively to obtain the visible light stitched image and the infrared stitched image.

Optionally, the constraint condition in S33 is as shown in the following formula (1):

$${p}_{bi} = {Hp}_{ai} \qquad ( 1 )$$

where

$$( \begin{matrix}{x}_{bi} \\ {y}_{bi} \\ 1\end{matrix} ) = ( \begin{matrix}{h}_{11} & {h}_{12} & {h}_{13} \\ {h}_{21} & {h}_{22} & {h}_{23} \\ {h}_{31} & {h}_{32} & 1\end{matrix} ) ( \begin{matrix}{x}_{ai} \\ {y}_{ai} \\ 1\end{matrix} ) \qquad ( 2 )$$

In the formula, p_{bi} and pₐᵢ represent the feature points of two adjacent visible light images a and b, H represents a homography transformation matrix, x_{bi} represents the abscissa of the i-th feature point in the image b corresponding to the image a, y_{bi} represents the ordinate of the i-th feature point in the image b corresponding to the image a, h₁₁, h₁₂, h₁₃, h₂₁, h₂₂, h₂₃, h₃₁, and h₃₂ represent parameters in the homography transformation matrix obtained by solving, xₐᵢ represents the abscissa of the i-th feature point in the image a corresponding to the image b, and yₐᵢ represents the ordinate of the i-th feature point in the image a corresponding to the image b.

Optionally, the stitching process in S35 is as shown in the following formula (3):

$$V = {\sum }_{i = 1}^{n - 1} {α}_{1} {I}_{i}^{v} + ( 1 - {α}_{1} ) {I}_{i + 1}^{v} \qquad ( 3 )$$

where

$${α}_{1} ( x , y ) = \frac{x - {x}_{1}}{{x}_{2} - {x}_{1}} \qquad ( 4 )$$

In the formula, V represents the stitched image, n represents the number of the sets of the images, α₁ represents the weight factor of the stitching process,

$${I}_{i}^{v}$$

represents the i-th set of visible light images, (x,y) represents the pixel position in the overlapping area, x₁ represents the left boundary of the overlapping area, and x₂ represents the right boundary of the overlapping area.

Optionally, the process of constructing the multi-modal perception detection network in S4 includes:
S41. acquiring a visible light stitched sample image and an infrared stitched sample image;
S42. performing feature map extraction on the visible light stitched sample image and the infrared stitched sample image by using MobileNet, to obtain a visible light feature map and an infrared feature map;
S43. adding numbers of channels of the visible light feature map and the infrared feature map to generate an added feature map, and respectively inputting the added feature map into three convolutional layers which are in jump connection to obtain a first feature map, a second feature map, and a third feature map;
S44. performing a convolution operation on the first feature map, the second feature map, and the third feature map respectively, to obtain a first dimensionality reduction result, a second dimensionality reduction result, and a third dimensionality reduction result;
S45. obtaining a predicted target position and target category according to the first dimensionality reduction result, the second dimensionality reduction result, and the third dimensionality reduction result; and
S46. constructing a loss function based on the predicted target position and target category, and training the multi-modal perception detection network based on the loss function to obtain a constructed multi-modal perception detection network.

Optionally, the loss function in S46 is as shown in the following formulas (5)-(8):

$${f}_{L 1} ( {P}_{p} , {P}_{l} ) = \{ \begin{matrix}0.5 \times {( {P}_{p} - {P}_{l} )}^{2} , & if \vert {P}_{p} - {P}_{l} \vert < 1 \\ \vert {P}_{p} - {P}_{l} \vert - 0.5 , & other\end{matrix} \qquad ( 5 )$$

$${loss}_{box} = {f}_{L 1} ( {x}_{p} , {x}_{l} ) + {f}_{L 1} ( {y}_{p} , {y}_{l} ) + {f}_{L 1} ( {w}_{p} , {w}_{l} ) + {f}_{L 1} ( {h}_{p} , {h}_{l} ) \qquad ( 6 )$$

$${loss}_{class} = - {\sum }_{i = 1}^{K} {y}_{i} log ( {p}_{i} ) \qquad ( 7 )$$

$$loss = {α}_{2} \times {loss}_{box} + ( 1 - {α}_{2} ) \times {loss}_{class} \qquad ( 8 )$$

In the formulas, f_{L1}(Pₚ,Pₗ) represents the specific calculation formula of the loss function, Pₚ) represents the predicted value, Pₗ represents the true value, loss_{box} represents the loss value of the target bounding box, f_{L1}(xₚ,xₗ) represents the loss value of the abscissa of the center point, xₚ represents the abscissa of the predicted target position of the center point, xₗ represents the abscissa of the true target position of the center point, f_{L1}(yₚ, yₗ) represents the loss value of the ordinate of the center point, yₚ represents the ordinate of the predicted target position of the center point, yₗ represents the ordinate of the true target position of the center point, f_{L1}(wₚ, wₗ) represents the loss value of the width of the target bounding box, wₚ represents the predicted width of the target bounding box, wₗ represents the true width of the target bounding box, f_{L1}(hₚ, hₗ) represents the loss value of the height of the target bounding box, hₚ represents the predicted height of the target bounding box, hₗ represents the true height of the target bounding box, loss_{class} represents the loss value of the target category information, K represents the number of target types, where if the target category is correct, yᵢ=1, otherwise yᵢ=0, pᵢ represents the probability value of being predicted as the target category, loss represents the loss function, and α₂ represents the weight parameter.

In another aspect, a multi-modal compound eye perception device for a complex degraded environment is provided, and the device is applied to a multi-modal compound eye perception method for a complex degraded environment. The device includes:
an acquisition module, configured to acquire multiple sets of images in the complex degraded environment through a multi-modal compound eye acquisition device, where each set of images in the multiple sets of images include a visible light image and an infrared image;
an extraction module, configured to input the multiple sets of images into a trained feature point prediction model to extract key feature point information in the visible light images and key feature point information in the infrared images;
a stitching module, configured to generate a visible light stitched image and an infrared stitched image according to a nearest neighbor matching technique, the key feature point information in the visible light images and the key feature point information in the infrared images; and
an output module, configured to input the visible light stitched image and the infrared stitched image into the constructed multi-modal perception detection network to perform target detection to obtain a multi-modal perception detection result.

Optionally, the extraction module is further configured to:
acquire a visible light sample image;
perform three convolution operations on the visible light sample image to obtain a first convolution feature map, a second convolution feature map, and a third convolution feature map, respectively;
perform a deconvolution operation on the first convolution feature map, the second convolution feature map, and the third convolution feature map respectively, to obtain a first deconvolution image, a second deconvolution image, and a third deconvolution image;
perform feature fusion on the first deconvolution image, the second deconvolution image, and the third deconvolution image to obtain a fused feature map;
input the fused feature map into a maximum pooling layer to obtain a maximum pooling layer output;
input the maximum pooling layer output into a bilinear interpolation layer to obtain a bilinear interpolation layer output;
input the bilinear interpolation layer output into a fully connected layer to obtain the key feature point information in the visible light sample image; and
train the feature point prediction model according to the key feature point information in the visible light sample image to obtain a trained feature point prediction model.

Optionally, the stitching module is further configured to:
acquire feature points of adjacent visible light images, and matching the acquired feature points by using the nearest neighbor matching technique to obtain a plurality of matched visible light image feature points;
acquire feature points of adjacent infrared images, and matching the acquired feature points by using the nearest neighbor matching technique to obtain a plurality of matched infrared image feature points;
establish a constraint condition according to the plurality of matched visible light image feature points;
perform homography transformation alignment on the visible light images and the infrared images respectively according to the constraint condition, the multiple matched visible light image feature points and the multiple matched infrared image feature points, to obtain aligned visible light images and aligned infrared images; and
stitch the aligned visible light images and the aligned infrared images respectively to obtain the visible light stitched image and the infrared stitched image.

Optionally, the constraint condition is as shown in the following formula (1):

$${p}_{bi} = {Hp}_{ai} \qquad ( 1 )$$

where

$$( \begin{matrix}{x}_{bi} \\ {y}_{bi} \\ 1\end{matrix} ) = ( \begin{matrix}{h}_{11} & {h}_{12} & {h}_{13} \\ {h}_{21} & {h}_{22} & {h}_{23} \\ {h}_{31} & {h}_{32} & 1\end{matrix} ) ( \begin{matrix}{x}_{ai} \\ {y}_{ai} \\ 1\end{matrix} ) \qquad ( 2 )$$

In the formula, p_{bi} and pₐᵢ represent the feature points of two adjacent visible light images a and b, H represents a homography transformation matrix, x_{bi} represents the abscissa of the i-th feature point in the image b corresponding to the image a, y_{bi} represents the ordinate of the i-th feature point in the image b corresponding to the image a, h₁₁, h₁₂, h₁₃, h₂₁, h₂₂, h₂₃, h₃₁, and h₃₂ represent parameters in the homography transformation matrix obtained by solving, xₐᵢ represents the abscissa of the i-th feature point in the image a corresponding to the image b, and yₐᵢ represents the ordinate of the i-th feature point in the image a corresponding to the image b.

Optionally, the stitching process is as shown in the following formula (3):

$$V = {\sum }_{i = 1}^{n - 1} {α}_{1} {I}_{i}^{ν} + ( 1 - {α}_{1} ) {I}_{i + 1}^{ν} \qquad ( 3 )$$

where

$${α}_{1} ( x , y ) = \frac{x - {x}_{1}}{{x}_{2} - {x}_{1}} \qquad ( 4 )$$

In the formula, V represents the stitched image, n represents the number of the sets of the images, α₁ represents the weight factor of the stitching process,

$${I}_{i}^{v}$$

represents the i-th set of visible light images, (x,y) represents the pixel position in the overlapping area, x₁ represents the left boundary of the overlapping area, and x₂ represents the right boundary of the overlapping area.

Optionally, the output module is further configured to:
S41. acquire a visible light stitched sample image and an infrared stitched sample image;
S42. perform feature map extraction on the visible light stitched sample image and the infrared stitched sample image by using MobileNet, to obtain a visible light feature map and an infrared feature map;
S43. add numbers of channels of the visible light feature map and the infrared feature map to generate an added feature map, and respectively input the added feature map into three convolutional layers which are in jump connection to obtain a first feature map, a second feature map, and a third feature map;
S44. perform a convolution operation on the first feature map, the second feature map, and the third feature map respectively, to obtain a first dimensionality reduction result, a second dimensionality reduction result, and a third dimensionality reduction result;
S45. obtain a predicted target position and target category according to the first dimensionality reduction result, the second dimensionality reduction result, and the third dimensionality reduction result; and
S46. construct a loss function based on the predicted target position and target category, and train the multi-modal perception detection network based on the loss function to obtain a constructed multi-modal perception detection network.

Optionally the loss function is as shown in the following formulas (5)-(8).

$${f}_{L 1} ( {P}_{p} , {P}_{l} ) = \{ \begin{matrix}0.5 \times {( {P}_{p} - {P}_{l} )}^{2} , & if \vert {P}_{p} - {P}_{l} \vert < 1 \\ \vert {P}_{p} - {P}_{l} \vert - 0.5 , & other\end{matrix} \qquad ( 5 )$$

$${loss}_{box} = {f}_{L 1} ( {x}_{p} , {x}_{l} ) + {f}_{L 1} ( {y}_{p} , {y}_{l} ) + {f}_{L 1} ( {w}_{p} , {w}_{l} ) + {f}_{L 1} ( {h}_{p} , {h}_{l} ) \qquad ( 6 )$$

$${loss}_{class} = - {\sum }_{i = 1}^{K} {y}_{i} log ( {p}_{i} ) \qquad ( 7 )$$

$$loss = {α}_{2} \times {loss}_{box} + ( 1 - {α}_{2} ) \times {loss}_{class} \qquad ( 8 )$$

In the formulas, f_{L1}(Pₚ, Pₗ) represents the specific calculation formula of the loss function, Pₚ represents the predicted value, Pₗ represents the true value, loss_{box} represents the loss value of the target bounding box, f_{L1}(xₚ, xₗ) represents the loss value of the abscissa of the center point, xₚ represents the abscissa of the predicted target position of the center point, xₗ represents the abscissa of the true target position of the center point, f_{L1}(yₚ, yₗ), represents the loss value of the ordinate of the center point, yₚ represents the ordinate of the predicted target position of the center point, yₗ represents the ordinate of the true target position of the center point, f_{L1}(wₚ, wₗ) represents the loss value of the width of the target bounding box, wₚ represents the predicted width of the target bounding box, wₗ represents the true width of the target bounding box, f_{L1}(hₚ, hₗ) represents the loss value of the height of the target bounding box, hₚ represents the predicted height of the target bounding box, hₗ represents the true height of the target bounding box, loss_{class} represents the loss value of the target category information, K represents the number of target types, where if the target category is correct, yᵢ=1, otherwise yᵢ=0, pᵢ represents the probability value of being predicted as the target category, loss represents the loss function, and α₂ represents the weight parameter.

In another aspect, a multi-modal compound eye perception device is provided. The multi-modal compound eye perception device includes: a processor; and a memory, where the memory stores computer-readable instructions, and when the computer-readable instructions are executed by the processor, any one of the above multi-modal compound eye perception methods for a complex degraded environment is implemented.

In another aspect, a computer-readable storage medium is provided, where at least one instruction is stored in the storage medium, and the at least one instruction is loaded and executed by a processor to implement any one of the above multi-modal compound eye perception methods for a complex degraded environment.

The beneficial effects brought about by the technical solutions provided by the embodiments of the present disclosure include at least the follows.

In the embodiments of the present disclosure, a deep learning algorithm is used to construct a feature point prediction model for multi-modal compound eye data in a complex degraded environment, and the nearest neighbor matching technique is used to realize the image stitching of visible light modality and infrared modality. In view of the feature point extraction requirements in the compound eye sensor, a feature point prediction model based on deep learning is constructed, and the convolutional neural network is used to realize the accurate prediction of key feature points. By calculating the homography transformation matrix for image stitching, the synchronous stitching of visible light images and infrared images is realized. For the target detection task of multi-modal compound eye stitched images, a lightweight multi-modal perception detection network is constructed, and MobileNet is used to extract features and fuse them, realizing the perception detection task in the complex degraded environment.

### BRIEF DESCRIPTION OF DRAWINGS

In order to more clearly illustrate the technical solutions in the embodiments of the present disclosure, the following briefly introduces the drawings required for use in the description of the embodiments. Obviously, the drawings described below are only some embodiments of the present disclosure. For those ordinarily skilled in the art, other drawings may be obtained based on these drawings without creative work.

FIG. 1 is a flow chart of a multi-modal compound eye perception method for a complex degraded environment provided by embodiments of the present disclosure;

FIG. 2 is a schematic framework diagram of a multi-modal compound eye perception method for a complex degraded environment provided by embodiments of the present disclosure;

FIG. 3 is a framework diagram of a feature point prediction model provided by embodiments of the present disclosure;

FIG. 4 is a flow chart of a multi-modal perception detection algorithm provided by embodiments of the present disclosure;

FIG. 5 is a block diagram of a multi-modal compound eye perception device for a complex degraded environment provided by embodiments of the present disclosure; and

FIG. 6 is a schematic structural view of a multi-modal compound eye perception device provided by embodiments of the present disclosure.

### DETAILED DESCRIPTION OF EMBODIMENTS

The technical solutions of the present disclosure are described below in conjunction with the drawings.

In the embodiments of the present disclosure, words such as “exemplarily” and “for example” are used to indicate examples, illustrations or explanations. Any embodiment or design described as “example” in the present disclosure should not be interpreted as being more preferred or more advantageous than other embodiments or designs. Exactly, the use of the word “example” is intended to present the concept in a specific way. In addition, in the embodiments of the present disclosure, the meaning expressed by “and/or” may be refer to that there are both, or there may be either of the two.

In the embodiments of the present disclosure, “image” and “picture” may sometimes be used interchangeably. It should be noted that when the difference between them is not emphasized, the meanings they intend to express are the same. “of”, “relevant” and “corresponding” may sometimes be used interchangeably. It should be noted that when the difference between them is not emphasized, the meanings they intend to express are the same.

In the embodiments of the present disclosure, sometimes a subscript such as W₁ may be written in a non-subscript form, such as W1. When the difference is not emphasized, the meanings they intend to express are the same.

In order to make the technical problems, technical solutions and advantages to be solved by the present disclosure clearer, a detailed description will be given below with reference to the drawings and specific embodiments.

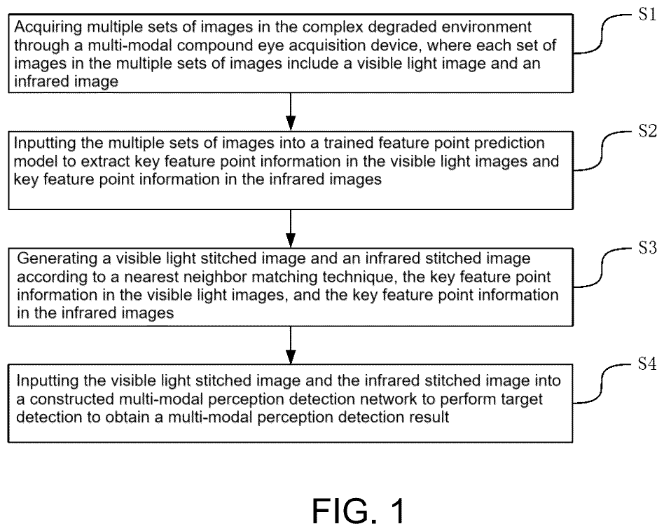

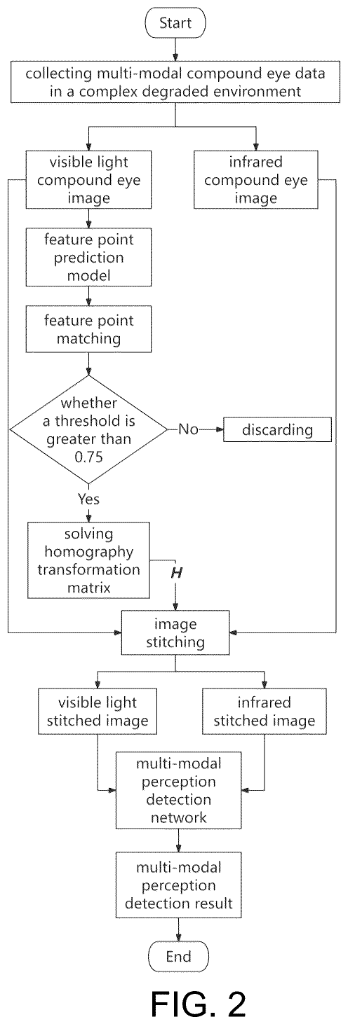

Embodiments of the present disclosure provides a multi-modal compound eye perception method for a complex degraded environment. The method may be implemented by a multi-modal compound eye perception device, which may be a terminal or a server. As shown in the flow chart of the multi-modal compound eye perception method for a complex degraded environment in FIG. 1 and FIG. 2, the processing flow of the method may include the following steps:

S1. acquiring multiple sets of images in a complex degraded environment through a multi-modal compound eye acquisition device, where each set of images in the multiple sets of images include a visible light image and an infrared image.

In a feasible implementation, multi-modal compound eye data is collected in a complex degraded environment, and the multi-modal compound eye data includes multiple visible light compound eye images and infrared compound eye images.

S2. inputting the multiple sets of images into a trained feature point prediction model to extract key feature point information in the visible light images and key feature point information in the infrared images.

In a feasible implementation, the present disclosure constructs, for the needs of feature point extraction in a compound eye sensor, a feature point prediction model using a convolutional neural network in deep learning; and the feature point prediction model based on the deep learning algorithm has stronger feature characterization ability, generalization ability and flexibility, compared with traditional methods, and the required feature point information can be accurately predicted through this model.

Optionally, the training process of the feature point prediction model in S2 may include the following steps S21-S28:

S21. acquiring a visible light sample image.

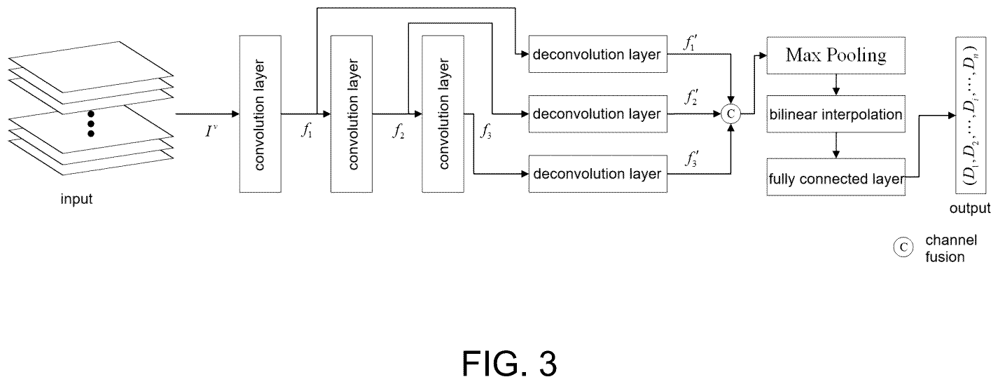

In a feasible implementation, as shown in FIG. 3, a multi-modal compound eye acquisition device is used to capture multiple sets of visible light images and infrared images in a complex degraded environment. Each group of multi-modal sensors is composed of a micro camera and a micro infrared camera which are registered. The data formula is expressed as:

$$I = ( {I}_{1} , {I}_{2} , {I}_{3} , … , {I}_{i} , … , {I}_{n} ) \qquad ( 1 )$$

$${I}_{i} = ( {I}_{i}^{v} , {I}_{i}^{In} ) \qquad ( 2 )$$

In the formula, Iᵢ represents the i-th set of visible light image and infrared image,

$${I}_{i}^{v} and {I}_{i}^{In}$$

are the visible light image and infrared image in the i-th set, respectively.

S22. performing three convolution operations on the visible light sample image to obtain a first convolution feature map, a second convolution feature map, and a third convolution feature map, respectively.

In a feasible implementation, three convolution operations are performed on the visible light sample image in step S21 to extract multi-scale similar feature point information in the image; and the convolution formula is expressed as:

$${f}_{1} = {I}^{v} \times conv ( 3 , 2 ) , {f}_{2} = {f}_{1} \times conv ( 3 , 2 ) , {f}_{3} = {f}_{2} \times conv ( 3 , 2 ) ) \qquad ( 3 )$$

In the above, conv(3,2) represents a convolution operation with a convolution kernel of 3×3 and a stride of 2;

$${f}_{1} ∈ {ℝ}^{\frac{H}{2} \times \frac{W}{2} \times C \times n} , {f}_{2} ∈ {ℝ}^{\frac{H}{4} \times \frac{W}{4} \times C \times n} \text{:} , and {f}_{3} ∈ {ℝ}^{\frac{H}{8} \times \frac{W}{8} \times C \times n}$$

represent three sets of feature maps extracted by the three convolution operations; and H, W and n represent the height, width and number of the set of the initial input image respectively, and C represents the number of channels.

S23. performing a deconvolution operation on the first convolution feature map, the second convolution feature map, and the third convolution feature map respectively, to obtain a first deconvolution image, a second deconvolution image, and a third deconvolution image.

In a feasible implementation, deconvolution operation is performed on f₁, f₂ and f₃ in step S22 respectively to generate f′₁, f′₂ and f′₃.

S24. performing feature fusion on the first deconvolution image, the second deconvolution image, and the third deconvolution image to obtain a fused feature map.

In a feasible implementation manner, f′₁, f′₂ and f′₃ are subjected to feature fusion to generate a feature map fₘ∈ [symbol] ^{H×W×3×n}.

$${f}_{i}^{′} = Deconv ( {f}_{i} ) \qquad ( 4 )$$

$$S ( {f}^{′} ) = σ ( {f}^{′} \times Conv ( 1 , 1 ) ) \qquad ( 5 )$$

$${f}_{m} = {\sum }_{i = 1}^{3} {S}_{i} ( {f}^{′} ) \cdot {f}_{i}^{′} \qquad ( 6 )$$

In the above, Deconv(fᵢ) is a 2ⁱ times deconvolution operation, i=(1,2,3); f′₁ is a feature map obtained by connecting the three feature maps f′₁, f′₂ and f′₃ along the channel dimensionality; and σ(⋅) is the sigmoid activation function.

S25. inputting the fused feature map into the maximum pooling layer to obtain a maximum pooling layer output.

In a feasible implementation, the output fₘ of step S24 is inputted to the Max Pooling layer, the Max Pooling layer divides the input feature map into several areas, with the maximum value of each area taken as the output, to retain the edge and texture information of the feature map:

$${f}_{{p}_{i , j}} = {max}_{( m , n ) ∈ {R}_{i , j}} {f}_{{m}_{m , n}} \qquad ( 7 )$$

In the above,

$${f}_{{p}_{i , i}} ∈ {ℝ}^{\frac{H}{2} \times \frac{W}{2} \times C \times n}$$

represents the value at the i-th row and j-th column of the output feature map; Rᵢⱼ represents the input feature map area corresponding to the i-th row and j-th column in the output feature map which has a size of 2×2, and fₘ_{_{m,n}} represents the value at the m-th row and n-th column the input feature map.

S26. inputting the maximum pooling layer output into the bilinear interpolation layer to obtain the bilinear interpolation layer output.

S27. inputting the bilinear interpolation layer output into the fully connected layer to obtain the key feature point information in the visible light sample image.

In a feasible implementation, the output fₚ of step S25 generates

$${f}_{p}^{′} ∈ {ℝ}^{H \times W \times C \times n}$$

through bilinear interpolation; and fₚ outputs feature point information D through a layer of a fully connected layer network:

$$D = ( {D}_{1} , {D}_{2} , {D}_{3} , ⋯ , {D}_{i} , ⋯ , {D}_{n} ) \qquad ( 8 )$$

$${D}_{i} = ( {d}_{1}^{i} , {d}_{2}^{i} , {d}_{3}^{i} , ⋯ , {d}_{j}^{i} ) \qquad ( 9 )$$

In the above, Di is a feature point set corresponding to the i-th visible light image;

$${d}_{j}^{i}$$

is the j-th feature point in the i-th visible light image, j≥4;

$${d}_{j}^{i}$$

contains the position information of the feature point and the descriptor information of the feature point. The descriptor contains the statistical information, gradient information, color histogram and other information of the area around the feature point.

S28. training the feature point prediction model according to the key feature point information in the visible light sample image to obtain a trained feature point prediction model.

In a feasible implementation, during the training phase, the obtained feature points are compared with the true values, and the interpolation with the true values is compared, to re-conduct the next training, and the weight parameter is continuously updated to enable the model to have the learning function.

S3. generating a visible light stitched image and an infrared stitched image according to a nearest neighbor matching technique, the key feature point information in the visible light images, and the key feature point information in the infrared images.

In a feasible implementation, the homography transformation matrix is calculated using the visible light images in the multi-modal compound eye and is synchronously applied to the infrared images.

Optionally, the above step S3 may include the following steps S31-S35:

S31. acquiring feature points of adjacent visible light images, and matching the acquired feature points by using the nearest neighbor matching technique to obtain a plurality of matched visible light image feature points.

In a feasible implementation, after the training of the feature point prediction model is completed, the trained model is used to extract feature points D in the visible light images; for adjacent visible light images, the nearest neighbor matching technique is used to match feature points, and the threshold is set to 0.75; the matching formula may be expressed as:

$${p}_{a} = arg {min}_{p ∈ {p}_{h}} dist ( {d}_{a} , {d}_{b} ) \qquad ( 10 )$$

$$dist ( {d}_{a} , {d}_{b} ) = \sqrt{{\sum }_{i = 1}^{n} {( {d}_{ai} - {d}_{bi} )}^{2}} \qquad ( 11 )$$

$$score ( {p}_{ai} , {p}_{bi} ) = \frac{1}{1 + dist ( {d}_{ai} + {d}_{bi} )} \qquad ( 12 )$$

In the above, pb represents the set of feature points in adjacent images; argmin represents the feature point with the smallest distance dist(dₐ,d_{b}); dₐ and d_{b} represent two descriptor vectors, each containing n features; dₐᵢ and d_{bi} represent the values of the i-th features in the two vectors; score (pₐᵢ,p_{bi}) represents the similarity of pₐᵢ and p_{bi}, and pₐᵢ and p_{bi} represent respectively the feature points in the two images, and are retained when the similarity is greater than or equal to the threshold.

S32, acquiring feature points of adjacent infrared images, and matching the acquired feature points by using the nearest neighbor matching technique to obtain a plurality of matched infrared image feature points.

S33. establishing a constraint condition according to the plurality of matched visible light image feature points.

In a feasible implementation, for N matched feature points in two adjacent visible light images, the following constraint condition may be established:

$${p}_{bi} = {Hp}_{ai} \qquad ( 13 )$$

where

$$( \begin{matrix}{x}_{bi} \\ {y}_{bi} \\ 1\end{matrix} ) = ( \begin{matrix}{h}_{11} & {h}_{12} & {h}_{13} \\ {h}_{21} & {h}_{22} & {h}_{23} \\ {h}_{31} & {h}_{32} & 1\end{matrix} ) ( \begin{matrix}{x}_{ai} \\ {y}_{ai} \\ 1\end{matrix} ) \qquad ( 14 )$$

In the formula, p_{bi} and pₐᵢ represent the feature points of two adjacent visible light images a and b, H represents a homography transformation matrix, x_{bi} represents the abscissa of the i-th feature point in the image b corresponding to the image a, y_{bi} represents the ordinate of the i-th feature point in the image b corresponding to the image a, h₁₁, h₁₂, h₁₃, h₂₁, h₂₂, h₂₃, h₃₁, and h₃₂ represent parameters in the homography transformation matrix obtained by solving, xₐᵢ represents the abscissa of the i-th feature point in the image a corresponding to the image b, yₐᵢ represents the ordinate of the i-th feature point in the image a corresponding to the image b. Formula (14) is the expanded term of formula (13).

S34. performing homography transformation alignment on the visible light images and the infrared images respectively according to the constraint condition, the multiple matched visible light image feature points and the multiple matched infrared image feature points, to obtain aligned visible light images and aligned infrared images.

S35. stitching the aligned visible light images and the aligned infrared images respectively to obtain the visible light stitched image and the infrared stitched image.

In a feasible implementation, homography transformation alignment is performed on all visible light images/′; and the aligned visible light images are stitched in pairs using the following formula to generate complete visible light stitched images V:

$$V = {\sum }_{i = 1}^{n - 1} {α}_{i} {I}_{i}^{v} + ( 1 - {α}_{1} ) {I}_{i + 1}^{v} \qquad ( 15 )$$

where

$${α}_{i} ( x , y ) = \frac{x - {x}_{1}}{{x}_{2} - {x}_{1}} \qquad ( 16 )$$

In the formula, V represents the stitched image, n represents the number of the sets of the images, α₁ represents the weight factor of the stitching process,

$${I}_{i}^{v}$$

represents the i-th set of visible light images, (x,y) represents the pixel position in the overlapping area, x₁ represents the left boundary of the overlapping area, and x₂ represents the right boundary of the overlapping area.

Further, since the micro infrared camera and the micro camera are registered, the infrared image I^{In} uses the steps corresponding to the visible light image I^{v} to generate complete infrared stitched images In.

S4. inputting the visible light stitched image and the infrared stitched image into the constructed multi-modal perception detection network to perform target detection to obtain the multi-modal perception detection result.

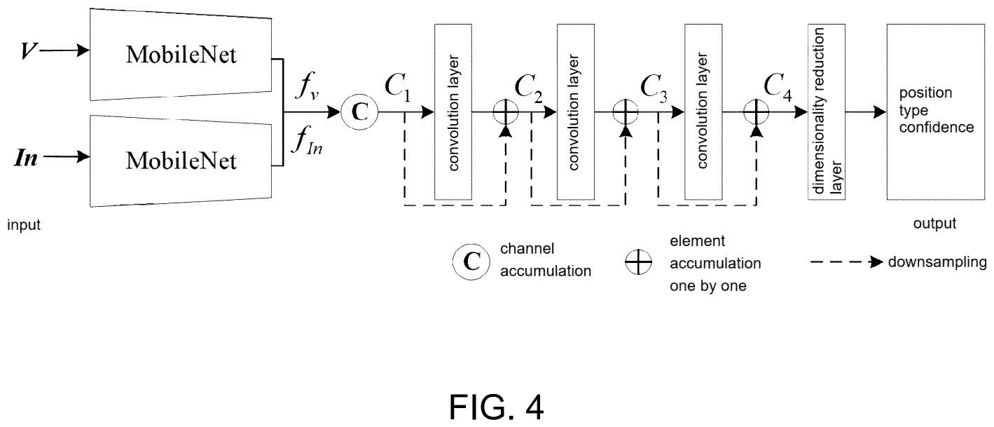

In a feasible implementation, as shown in FIG. 4, a lightweight backbone network MobileNet is used to extract feature information of visible light images and infrared images after compound eye image stitching, perform feature fusion, and finally predict target information. Different from the existing target detection network, the present disclosure constructs a lightweight multi-modal perception detection network to address the problem of large image scale after compound eye stitching; and meanwhile, integrates the multi-modal information in the compound eyes, which can perform perception detection tasks in real time in the complex degraded environment.

Optionally, the process of constructing the multi-modal perception detection network in S4 may include the following steps S41-S46:

S41, acquiring a visible light stitched sample image and an infrared stitched sample image.

S42. performing feature map extraction on the visible light stitched sample image and the infrared stitched sample image by using MobileNet to obtain a visible light feature map and an infrared feature map.

In a feasible implementation, MobileNet is used to extract feature maps of the visible light stitched image V and the infrared stitched image In, respectively:

$${f}_{v} = MobileNet ( V ) \qquad ( 17 )$$

$${f}_{In} = MobileNet ( In ) \qquad ( 18 )$$

In the above, MobileNet(⋅) represents a lightweight backbone network; and fᵥ and f_{In} represent the feature map of V and the feature map of In, respectively.

S43. adding numbers of channels of the visible light feature map and the infrared feature map to generate an added feature map, and respectively inputting the added feature map into three convolutional layers which are in jump connection to obtain a first feature map, a second feature map, and a third feature map.

In a feasible implementation, numbers of channels of fᵥ and f_{In} are added to generate a feature map C₁, C₁ is inputted into three convolutional layers which are in jump connection to obtain feature maps C₂, C₃, and C₄ having multi-scale information:

$${C}_{i + 1} = F ( {C}_{i} ) + Down ( {C}_{i} , 2 ) \qquad ( 19 )$$

$$F ( x ) = x \times conv ( 3 , 2 ) \qquad ( 20 )$$

In the above, conv(3,2) represents a convolution operation with a convolution kernel of 3×3 and a stride of 2; Cᵢ represents the input of this convolution layer; Cᵢ₊₁ represents the output of this convolution layer, i=(1,2,3), and Down(⋅) represents 2 times downsampling.

S44. performing a convolution operation on the first feature map, the second feature map, and the third feature map respectively, to obtain a first dimensionality reduction result, a second dimensionality reduction result, and a third dimensionality reduction result.

S45. obtaining a predicted target position and target category according to the first dimensionality reduction result, the second dimensionality reduction result, and the third dimensionality reduction result.

In a feasible implementation, C₂, C₃, and C₄ are subjected to dimensionality reduction respectively using 1×1 convolution operation; and the position (x,y,w,h), category and confidence of the image target are predicted through the three dimensionality reduction results, where (x,y,w,h) represents the coordinates (x,y) of the target position of the center point and the width and height of the target bounding box.

S46. constructing a loss function based on the predicted target position and target category, and training the multi-modal perception detection network based on the loss function to obtain a constructed multi-modal perception detection network.

In a feasible implementation, during the training phase, the next training is re-performed based on the loss function loss between the target position and category information obtained by calculation and the true value, and the weight parameter is continuously updated to enable the model to have a learning function; the loss function is expressed as follows:

$${f}_{L 1} ( {P}_{p} , {P}_{l} ) = \{ \begin{matrix}0.5 \times {( {P}_{p} - {P}_{l} )}^{2} , & if \vert {P}_{p} - {P}_{l} \vert < 1 \\ \vert {P}_{p} - {P}_{l} \vert - 0.5 , & other\end{matrix} \qquad ( 21 )$$

$${loss}_{box} = {f}_{L 1} ( {x}_{p} , {x}_{l} ) + {f}_{L 1} ( {y}_{p} , {y}_{l} ) + {f}_{L 1} ( {w}_{p} , {w}_{l} ) + {f}_{L 1} ( {h}_{p} , {h}_{l} ) \qquad ( 22 )$$

$${loss}_{class} = - {\sum }_{i = 1}^{K} {y}_{i} log ( {p}_{i} ) \qquad ( 23 )$$

$$loss = {α}_{2} \times {loss}_{box} + ( 1 - {α}_{2} ) \times {loss}_{class} \qquad ( 24 )$$

In the above, Pₚ and pₗ represent the predicted value and the true value, respectively; (xₚ,yₚ,wₚ,hₚ) and (x₁,y₁,w₁,h₁) represent the predicted target position information and the true target position information respectively; K represents the number of target types, where if the target category is correct, yᵢ=1, otherwise yᵢ=0; and α₂ represents the weight parameter, which is set to be 0.8.

The present disclosure uses a deep learning algorithm to construct a feature point prediction model. The nearest neighbor matching technique is used to match the feature points of adjacent images, and the homography transformation matrix is solved for image stitching to generate a visible light stitched image and an infrared stitched image respectively. A multi-modal perception detection network is constructed to perform target detection on infrared images and the visible light images, and finally the center point coordinates, width, height and other information of the target bounding box in the image are obtained.

In the embodiments of the present disclosure, a deep learning algorithm is used to construct a feature point prediction model for multi-modal compound eye data in a complex degraded environment, and the nearest neighbor matching technique is used to realize the image stitching of visible light modality and infrared modality. In view of the feature point extraction requirements in the compound eye sensor, a feature point prediction model based on deep learning is constructed, and the convolutional neural network is used to realize the accurate prediction of key feature points. By calculating the homography transformation matrix for image stitching, the synchronous stitching of visible light images and infrared images is realized. For the target detection task of multi-modal compound eye stitched images, a lightweight multi-modal perception detection network is constructed, and MobileNet is used to extract features and fuse them, realizing the perception detection task in the complex degraded environment.

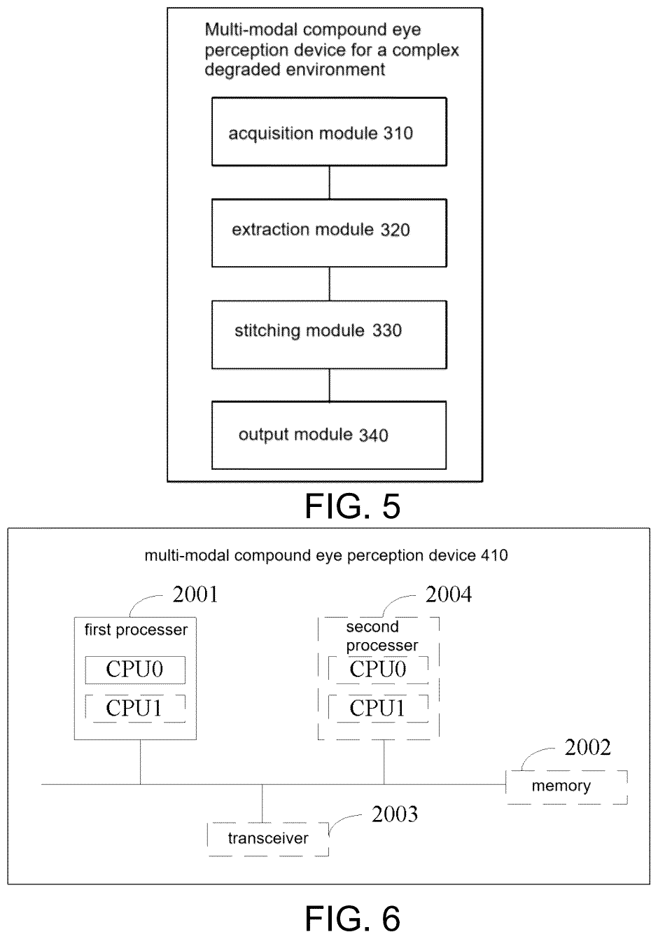

FIG. 5 is a block diagram of a multi-modal compound eye perception device for a complex degraded environment shown according to an exemplary embodiment, and the device is used for a multi-modal compound eye perception method for a complex degraded environment. Referring to FIG. 5, the device includes an acquisition module 310, an extraction module 320, a stitching module 330, and an output module 340. In the above:

the acquisition module 310 is configured to acquire multiple sets of images in the complex degraded environment through a multi-modal compound eye acquisition device, where each set of images in the multiple sets of images include a visible light image and an infrared image.

The extraction module 320 is configured to input the multiple sets of images into the trained feature point prediction model to extract key feature point information in the visible light images and key feature point information in the infrared images.

The stitching module 330 is configured to generate a visible light stitched image and an infrared stitched image according to the nearest neighbor matching technique, the key feature point information in the visible light images and the key feature point information in the infrared images.

The output module 340 is configured to input the visible light stitched image and the infrared stitched image into the constructed multi-modal perception detection network to perform target detection to obtain a multi-modal perception detection result.

Optionally, the extraction module 320 is further configured to:
acquire a visible light sample image;
perform three convolution operations on the visible light sample image to obtain a first convolution feature map, a second convolution feature map, and a third convolution feature map, respectively;
perform a deconvolution operation on the first convolution feature map, the second convolution feature map, and the third convolution feature map respectively, to obtain a first deconvolution image, a second deconvolution image, and a third deconvolution image;
perform feature fusion on the first deconvolution image, the second deconvolution image, and the third deconvolution image to obtain a fused feature map;
input the fused feature map into a maximum pooling layer to obtain a maximum pooling layer output;
input the maximum pooling layer output into a bilinear interpolation layer to obtain a bilinear interpolation layer output;
input the bilinear interpolation layer output into a fully connected layer to obtain the key feature point information in the visible light sample image; and
train the feature point prediction model according to the key feature point information in the visible light sample image to obtain a trained feature point prediction model.

Optionally, the stitching module 330 is further configured to:
acquire feature points of adjacent visible light images, and matching the acquired feature points by using the nearest neighbor matching technique to obtain a plurality of matched visible light image feature points;
acquire feature points of adjacent infrared images, and matching the acquired feature points by using the nearest neighbor matching technique to obtain a plurality of matched infrared image feature points;
establish a constraint condition according to the plurality of matched visible light image feature points;
perform homography transformation alignment on the visible light images and the infrared images respectively according to the constraint condition, the multiple matched visible light image feature points and the multiple matched infrared image feature points, to obtain aligned visible light images and aligned infrared images; and stitch the aligned visible light images and the aligned infrared images respectively to obtain the visible light stitched image and the infrared stitched image.

Optionally, the constraint condition is as shown in the following formula (1):

$${p}_{bi} = {Hp}_{ai} \qquad ( 1 )$$

where

$$( \begin{matrix}{x}_{bi} \\ {y}_{bi} \\ 1\end{matrix} ) = ( \begin{matrix}{h}_{11} & {h}_{12} & {h}_{13} \\ {h}_{21} & {h}_{22} & {h}_{23} \\ {h}_{31} & {h}_{32} & 1\end{matrix} ) ( \begin{matrix}{x}_{ai} \\ {y}_{ai} \\ 1\end{matrix} ) \qquad ( 2 )$$

In the formula, p_{bi} and pₐᵢ represent the feature points of two adjacent visible light images a and b, H represents a homography transformation matrix, x_{bi} represents the abscissa of the i-th feature point in the image b corresponding to the image a, y_{bi} represents the ordinate of the i-th feature point in the image b corresponding to the image a, h₁₁, h₁₂, h₁₃, h₂₁, h₂₂, h₂₃, h₃₁, and h₃₂ represent parameters in the homography transformation matrix obtained by solving, xₐᵢ represents the abscissa of the i-th feature point in the image a corresponding to the image b, and yₐᵢ represents the ordinate of the i-th feature point in the image a corresponding to the image b.

Optionally, the stitching process is as shown in the following formula (3):

$$V = {\sum }_{i = 1}^{n - 1} {α}_{1} {I}_{i}^{v} + ( 1 - {α}_{1} ) {I}_{i + 1}^{v} \qquad ( 3 )$$

where

$${α}_{1} ( x , y ) = \frac{x - {x}_{1}}{{x}_{2} - {x}_{1}} \qquad ( 4 )$$

In the formula, V represents the stitched image, n represents the number of the sets of the images, α₁ represents the weight factor of the stitching process,

$${I}_{i}^{ν}$$

represents the i-th set of visible light images, (x,y) represents the pixel position in the overlapping area, x₁ represents the left boundary of the overlapping area, and x₂ represents the right boundary of the overlapping area.

Optionally, the output module 340 is further configured to:
S41. acquire a visible light stitched sample image and an infrared stitched sample image;
S42. perform feature map extraction on the visible light stitched sample image and the infrared stitched sample image by using MobileNet, to obtain a visible light feature map and an infrared feature map;
S43. add numbers of channels of the visible light feature map and the infrared feature map to generate an added feature map, and respectively input the added feature map into three convolutional layers which are in jump connection to obtain a first feature map, a second feature map, and a third feature map;
S44. perform a convolution operation on the first feature map, the second feature map, and the third feature map respectively, to obtain a first dimensionality reduction result, a second dimensionality reduction result, and a third dimensionality reduction result;
S45. obtain a predicted target position and target category according to the first dimensionality reduction result, the second dimensionality reduction result, and the third dimensionality reduction result; and
S46. construct a loss function based on the predicted target position and target category, and train the multi-modal perception detection network based on the loss function to obtain a constructed multi-modal perception detection network.

Optionally, the loss function is as shown in the following formulas (5)-(8):

$${f}_{L 1} ( {P}_{p} , {P}_{l} ) = \{ \begin{matrix}0.5 \times {( {P}_{p} - {P}_{l} )}^{2} , & if \vert {P}_{p} - {P}_{l} \vert < 1 \\ \vert {P}_{p} - {P}_{l} \vert - 0.5 , & other\end{matrix} \qquad ( 5 )$$

$${loss}_{box} = {f}_{L 1} ( {x}_{p} , {x}_{l} ) + {f}_{L 1} ( {y}_{p} , {y}_{l} ) + {f}_{L 1} ( {w}_{p} , {w}_{l} ) + {f}_{L 1} ( {h}_{p} , {h}_{l} ) \qquad ( 6 )$$

$${loss}_{class} = - {\sum }_{i = 1}^{K} {y}_{i} log ( {p}_{i} ) \qquad ( 7 )$$

$$loss = {α}_{2} \times {loss}_{box} + ( 1 - {α}_{2} ) \times {loss}_{class} \qquad ( 8 )$$

In the formulas, f_{L1}(Pₚ, Pₗ) represents the specific calculation formula of the loss function, Pₚ represents the predicted value, Pₗ represents the true value, loss_{box} represents the loss value of the target bounding box, f_{L1}(xₚ,xₗ) represents the loss value of the abscissa of the center point, xₚ represents the abscissa of the predicted target position of the center point, xₗ represents the abscissa of the true target position of the center point, f_{L1}(yₚ, yₗ) represents the loss value of the ordinate of the center point, yₚ represents the ordinate of the predicted target position of the center point, yₗ represents the ordinate of the true target position of the center point, f_{L1}(wₚ, wₗ) represents the loss value of the width of the target bounding box, wₚ represents the predicted width of the target bounding box, wₗ represents the true width of the target bounding box, f_{L1}(hₚ, hₗ) represents the loss value of the height of the target bounding box, represents the predicted height of the target bounding box, hₗ represents the true height of the target bounding box, loss_{class} represents the loss value of the target category information, K represents the number of target types, where if the target category is correct, yᵢ=1, otherwise yᵢ=0, pᵢ represents the probability value of being predicted as the target category, loss represents the loss function, and α₂ represents the weight parameter.

In the embodiments of the present disclosure, a deep learning algorithm is used to construct a feature point prediction model for multi-modal compound eye data in a complex degraded environment, and the nearest neighbor matching technique is used to realize the image stitching of visible light modality and infrared modality. In view of the feature point extraction requirements in the compound eye sensor, a feature point prediction model based on deep learning is constructed, and the convolutional neural network is used to realize the accurate prediction of key feature points. By calculating the homography transformation matrix for image stitching, the synchronous stitching of visible light images and infrared images is realized. For the target detection task of multi-modal compound eye stitched images, a lightweight multi-modal perception detection network is constructed, and MobileNet is used to extract features and fuse them, realizing the perception detection task in the complex degraded environment.

FIG. 6 is a schematic structural view of a multi-modal compound eye perception device provided by embodiments of the present disclosure. As shown in FIG. 6, the multi-modal compound eye perception device may include the multi-modal compound eye perception device for a complex degraded environment shown in FIG. 5. Optionally, the multi-modal compound eye perception device 410 may include a first processor 2001.

Optionally, the multi-modal compound eye perception device 410 may also include a memory 2002 and a transceiver 2003.

In the above, the first processor 2001, the memory 2002 and the transceiver 2003 may be connected via a communication bus.

Detailed introductions will be made to the various components of the multi-modal compound eye perception device 410 in conjunction with FIG. 6.

In the above, the first processor 2001 is the control center of the multi-modal compound eye perception device 410, which may be a processor or a general term for multiple processing elements. For example, the first processor 2001 may refer to one or more central processing units (CPUs), may be an application specific integrated circuit (ASIC), or may be one or more integrated circuits configured to implement the embodiments of the present disclosure, such as one or more microprocessors (digital signal processors, DSPs), or one or more field programmable gate arrays (FPGAs).

Optionally, the first processor 2001 may execute various functions of the multi-modal compound eye perception device 410 by running or executing a software program stored in the memory 2002 and calling data stored in the memory 2002.

In a specific implementation, as an example, the first processor 2001 may include one or more CPUs, for example, CPU0 and CPU1 shown in FIG. 6.

In a specific implementation, as an embodiment, the multi-modal compound eye perception device 410 may also include multiple processors, for example, the first processor 2001 and the second processor 2004 shown in FIG. 6. Each of these processors may be a single-core processor (single-CPU) or a multi-core processor (multi-CPU). The processor here may refer to one or more devices, circuits, and/or processing cores for processing data (for example, computer program instructions).

In the above, the memory 2002 is used to store the software program for executing the solution of the present disclosure which is controlled to be executed by the first processor 2001. The specific implementation may refer to the above method embodiments, which will not be repeated here.

Optionally, the memory 2002 may be a read-only memory (ROM) or other type of static storage device that can store static information and instructions, a random access memory (RAM) or other type of dynamic storage device that can store information and instructions, or may be an electrically erasable programmable read-only memory (EEPROM), a compact disc read-only memory (CD-ROM) or other optical disc storage, optical disc storage (including compressed optical disc, laser disc, optical disc, digital versatile disc, Blu-ray disc, etc.), a magnetic disk storage medium or other magnetic storage device, or any other medium that can be used to carry or store desired program codes in the form of instructions or data structures and can be accessed by a computer, but is not limited thereto. The memory 2002 may be integrated with the first processor 2001, or may exist independently, and be coupled to the first processor 2001 through the interface circuit (not shown in FIG. 6) of the multi-modal compound eye perception device 410, which is not specifically limited in the embodiment of the present disclosure.

The transceiver 2003 is used to communicate with a network device or a terminal device.

Optionally, the transceiver 2003 may include a receiver and a transmitter (not shown separately in FIG. 6), where the receiver is used to implement a receiving function, and the transmitter is used to implement a sending function.

Optionally, the transceiver 2003 may be integrated with the first processor 2001, or may exist independently and be coupled to the first processor 2001 through an interface circuit (not shown in FIG. 6) of the multi-modal compound eye perception device 410, which is not specifically limited in the embodiment of the present disclosure.

It should be indicated that the structure of the multi-modal compound eye perception device 410 shown in FIG. 6 does not constitute a limitation on the router, and the actual knowledge structure recognition device may include more or fewer components than those shown in the drawings, a combination of some components, or different arrangement of components.

In addition, the technical effects of the multi-modal compound eye perception device 410 can refer to the technical effects of the multi-modal compound eye perception method for a complex degraded environment described in the above method embodiments, which will not be repeated here.

It should be understood that the first processor 2001 in the embodiments of the present disclosure may be a central processing unit (CPU), and the processor may also be other general-purpose processor, digital signal processor (DSP), application specific integrated circuit (ASIC), field programmable gate array (FPGA) or other programmable logic device, discrete gate or transistor logic device, discrete hardware component, etc. The general-purpose processor may be a microprocessor or the processor may also be any conventional processor, etc.

It should also be understood that the memory in the embodiments of the present disclosure may be a volatile memory or a non-volatile memory, or may include both volatile and non-volatile memories. Among them, the non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), which is used as an external cache. By way of exemplary, not limiting description, many forms of random access memory (RAM) are available, such as static RAM (SRAM), dynamic random access memory (DRAM), synchronous DRAM (SDRAM), double data rate SDRAM (DDR SDRAM), enhanced SDRAM (ESDRAM), synchlink DRAM (SLDRAM), and direct rambus RAM (DR RAM).

The above embodiments may be all or partially implemented by software, hardware (such as circuit), firmware or any other combination. When implemented by using software, the above embodiments may be all or partially implemented in the form of a computer program product. The computer program product includes one or more computer instructions or computer programs. When the computer instructions or computer programs are loaded or executed on a computer, processes or functions described according to the embodiments of the present disclosure are all or partially generated. The computer may be a general-purpose computer, a special-purpose computer, a computer network, or other programmable device. The computer instructions may be stored in a computer-readable storage medium, or transmitted from one computer-readable storage medium to another computer-readable storage medium. For example, the computer instructions may be transmitted from one website, computer, server or data center to another website, computer, server or data center by wired (such as infrared, wireless, microwave, etc.) manner. The computer-readable storage medium may be any available medium that can be accessed by a computer or a data storage device such as a server or data center that contains one or more available media sets. The available medium may be a magnetic medium (for example, a floppy disk, a hard disk, a tape), an optical medium (for example, a DVD), or a semiconductor medium. The semiconductor medium may be a solid-state hard disk.

It should be understood that the term “and/or” herein is only used to describe the association relationship of associated objects, indicating that there may be three relationships. For example, A and/or B may indicate three situations: A exists alone, A and B both exist, and B exists alone, where A and B may be singular or plural. In addition, the character “/” herein generally indicates that the associated objects therebefore and thereafter are in an “or” relationship, but it may also indicate an “and/or” relationship, which may refer to the context for specific understanding.

In the present disclosure, “at least one” means one or more, and “plurality/multiple” means two or more. “At least one of the following (items)” or similar expression refers to any combination of these items, including any combination of single or plural items. For example, at least one of a, b, or c may mean: a, b, c, a-b, a-c, b-c, or a-b-c, where a, b, and c may be singular or plural.

It should be understood that in various embodiments of the present disclosure, the serial numbers of the above-mentioned processes do not mean the execution order. The execution order of the individual processes should be determined by its function and internal logic, and should not constitute any limitation on the implementation process of the embodiments of the present disclosure.

Those skilled in the art will appreciate that the units and algorithm steps of each example described in conjunction with the embodiments disclosed herein may be implemented in electronic hardware, or a combination of computer software and electronic hardware. Whether these functions are performed in hardware or software depends on the specific application and design constraint conditions of the technical solution. Professional and technical personnel may use different methods to implement the described functions for each specific application, but such implementation should not be considered to be beyond the scope of the present disclosure.

Those skilled in the art can clearly understand that for the convenient and brief description, the specific working processes of the above-described equipment, devices and units may refer to the corresponding processes in the aforementioned method embodiments and will not be repeated here.

In the several embodiments provided by the present disclosure, it should be understood that the disclosed devices, apparatuses and methods may be implemented in other ways. For example, the device embodiments described above are only schematic. For example, the division of the units is only a logical function division. There may be other division methods in actual implementation. For example, multiple units or components may be combined or integrated into another device, or some features may be ignored or not executed. Another point is that the mutual coupling or direct coupling or communication shown or discussed may be indirect coupling or communication through some interfaces, devices or units, which may be electrical, mechanical or in other forms.

The units described as separate components may or may not be physically separated, and the components displayed as units may or may not be physical units, that is, they may be located in one place or distributed on multiple network units. Some or all of the units may be selected according to actual needs to achieve the purpose of the solutions of the embodiments.

In addition, the individual functional units in individual embodiments of the present disclosure may be integrated into one processing unit, or the individual units may exist physically separately, or two or more units may be integrated into one unit.

If the functions are implemented in the form of software functional units and sold or used as independent products, they may be stored in a computer-readable storage medium. Based on this understanding, the technical solution of the present disclosure, or the part that contributes to the prior art or a part of the technical solution may be embodied in the form of a software product. The computer software product is stored in a storage medium, including several instructions for enabling a computer device (which may be a personal computer, server, or network device, etc.) to execute all or part of the steps of the methods described in various embodiments of the present disclosure. The aforementioned storage medium includes: U disk, mobile hard disk, read-only memory (ROM), random access memory (RAM), disk or optical disk, and other media that may store program codes.

The above are only specific embodiments of the present disclosure, but the protection scope of the present disclosure is not limited thereto. Any person skilled in the art who is familiar with the art may easily think of changes or substitutions within the technical scope disclosed by the present disclosure, which should be included in the protection scope of the present disclosure. Therefore, the protection scope of the present disclosure shall be subjected to the protection scope of the claims.

1. A multi-modal compound eye perception method for a complex degraded environment, comprising:
S1, acquiring multiple sets of images in the complex degraded environment through a multi-modal compound eye acquisition device, wherein each set of images in the multiple sets of images comprise a visible light image and an infrared image;
S2, inputting the multiple sets of images into a trained feature point prediction model, and extracting key feature point information in the visible light images and key feature point information in the infrared images;
S3, generating a visible light stitched image and an infrared stitched image according to a nearest neighbor matching technique, the key feature point information in the visible light images, and the key feature point information in the infrared images; and
S4, inputting the visible light stitched image and the infrared stitched image into a constructed multi-modal perception detection network to perform target detection to obtain a multi-modal perception detection result.

2. The multi-modal compound eye perception method for a complex degraded environment according to claim 1, wherein a training process of a feature point prediction model in S2 comprises:
S21, acquiring a visible light sample image;
S22, performing three convolution operations on the visible light sample image to obtain a first convolution feature map, a second convolution feature map, and a third convolution feature map, respectively;
S23, performing a deconvolution operation on the first convolution feature map, the second convolution feature map, and the third convolution feature map respectively, to obtain a first deconvolution image, a second deconvolution image, and a third deconvolution image;
S24, performing feature fusion on the first deconvolution image, the second deconvolution image, and the third deconvolution image to obtain a fused feature map;
S25, inputting the fused feature map into the maximum pooling layer to obtain a maximum pooling layer output;
S26, inputting the maximum pooling layer output into a bilinear interpolation layer to obtain a bilinear interpolation layer output;
S27, inputting the bilinear interpolation layer output into a fully connected layer to obtain key feature point information in the visible light sample image; and
S28, training the feature point prediction model according to the key feature point information in the visible light sample image to obtain the trained feature point prediction model.

3. The multi-modal compound eye perception method for a complex degraded environment according to claim 1, wherein the generating the visible light stitched image and the infrared stitched image according to the nearest neighbor matching technique, the key feature point information in the visible light images and the key feature point information in the infrared images in S3 comprises:
S31, acquiring feature points of adjacent visible light images, and matching the acquired feature points using the nearest neighbor matching technique to obtain a plurality of matched visible light image feature points;
S32, acquiring feature points of adjacent infrared images, and matching the acquired feature points using the nearest neighbor matching technique to obtain a plurality of matched infrared image feature points;
S33, establishing a constraint condition according to the plurality of matched visible light image feature points;
S34, performing homography transformation alignment on the visible light images and the infrared images respectively according to the constraint condition, the plurality of matched visible light image feature points, and the plurality of matched infrared image feature points, to obtain aligned visible light images and aligned infrared images; and
S35, respectively stitching the aligned visible light images and the aligned infrared images to obtain a visible light stitched image and an infrared stitched image.

4. The multi-modal compound eye perception method for a complex degraded environment according to claim 3, wherein the constraint condition in S33 is as shown in a following formula (1):
$${p}_{bi} = {Hp}_{a i} \qquad ( 1 )$$
wherein
$$( \begin{matrix}{x}_{bi} \\ {y}_{bi} \\ 1\end{matrix} ) = ( \begin{matrix}{h}_{11} & {h}_{12} & {h}_{13} \\ {h}_{21} & {h}_{22} & {h}_{23} \\ {h}_{31} & {h}_{32} & 1\end{matrix} ) ( \begin{matrix}{x}_{ai} \\ {y}_{ai} \\ 1\end{matrix} ) \qquad ( 2 )$$
in the formula, p_{bi} and pₐᵢ represent feature points of two adjacent visible light images a and b, H represents a homography transformation matrix, x_{bi} represents an abscissa of an i-th feature point in the image b corresponding to the image a, y_{bi} represents an ordinate of the i-th feature point in the image b corresponding to the image a, h₁₁, h₁₂, h₁₃, h₂₁, h₂₂, h₂₃, h₃₁, and h₃₂ represent parameters in the homography transformation matrix obtained by solving, xₐᵢ represents an abscissa of an i-th feature point in the image a corresponding to the image b, and yₐᵢ represents an ordinate of the i-th feature point in the image a corresponding to the image b.

5. The multi-modal compound eye perception method for a complex degraded environment according to claim 3, wherein a stitching process in S35 is as shown in a following formula (3):
$$V = {\sum }_{i = 1}^{n - 1} {α}_{1} {I}_{i}^{ν} + ( 1 - {α}_{1} ) {I}_{i + 1}^{ν} \qquad ( 3 )$$
wherein
$${α}_{1} ( x , y ) = \frac{x - {x}_{1}}{{x}_{2} - {x}_{1}} \qquad ( 4 )$$
in the formular, V represents a stitched image, n represents number of sets of images, α₁ represents a weight factor of the stitching process,
$${I}_{i}^{v}$$
represents an i-th set of visible light images, (x,y) represents a pixel position in an overlapping area, x₁ represents a left boundary of the overlapping area, and x₂ represents a right boundary of the overlapping area.

6. The multi-modal compound eye perception method for a complex degraded environment according to claim 1, wherein a process of constructing the multi-modal perception detection network in S4 comprises:
S41, acquiring a visible light stitched sample image and an infrared stitched sample image;
S42, performing feature map extraction on the visible light stitched sample image and the infrared stitched sample image through MobileNet, to obtain a visible light feature map and an infrared feature map;
S43, adding numbers of channels of the visible light feature map and the infrared feature map to generate an added feature map, and respectively inputting the added feature map into three convolutional layers which are in jump connection to obtain a first feature map, a second feature map, and a third feature map;
S44, performing a convolution operation on the first feature map, the second feature map, and the third feature map respectively, to obtain a first dimensionality reduction result, a second dimensionality reduction result, and a third dimensionality reduction result;
S45, obtaining a predicted target position and target category according to the first dimensionality reduction result, the second dimensionality reduction result, and the third dimensionality reduction result;
S46, constructing a loss function according to the predicted target position and target category, and training the multi-modal perception detection network according to the loss function to obtain the constructed multimodal perception detection network.

7. The multi-modal compound eye perception method for a complex degraded environment according to claim 6, wherein the loss function in S46 is as shown in following formulas (5)-(8):
$${f}_{L 1} ( {P}_{p} , {P}_{l} ) = \{ \begin{matrix}0.5 \times {( {P}_{p} - {P}_{l} )}^{2} , & if \vert {P}_{p} - {P}_{l} \vert < 1 \\ \vert {P}_{p} - {P}_{l} \vert - 0.5 , & other\end{matrix} \qquad ( 5 )$$
$${loss}_{box} = {f}_{L 1} ( {x}_{p} , {x}_{l} ) + {f}_{L 1} ( {y}_{p} , {y}_{l} ) + {f}_{L 1} ( {w}_{p} , {w}_{l} ) + {f}_{L 1} ( {h}_{p} , {h}_{l} ) \qquad ( 6 )$$
$${loss}_{class} = - {\sum }_{i = 1}^{K} {y}_{i} log ( {p}_{i} ) \qquad ( 7 )$$
$$loss = {α}_{2} \times {loss}_{box} + ( 1 - {α}_{2} ) \times {loss}_{class} \qquad ( 8 )$$
in the formulas, f_{L1}(Pₚ, Pₗ) represents a calculation formula of the loss function, represents a predicted value, Pₗ represents a true value, loss_{box} represents a loss value of a target bounding box, f_{L1}(xₚ, xₗ) represents a loss value of an abscissa of a center point, xₚ represents an abscissa of a predicted target position of the center point, xₗ represents an abscissa of a true target position of the center point, f_{L1}(yₚ, yₗ) represents a loss value of an ordinate of the center point, yₚ represents an ordinate of a predicted target position of the center point, yₗ represents an ordinate of a target position of the center point, f_{L1}(wₚ, wₗ) represents a loss value of a width of the target bounding box, wₚ represents a predicted width of the target bounding box, wₗ represents a true width of the target bounding box, f_{L1}(hₚ, hₗ) represents a loss value of a height of the target bounding box, hₚ represents a predicted height of the target bounding box, hₗ represents a true height of the target bounding box, loss_{class} represents a loss value of the target category information, K represents number of target types, wherein if a target category is correct, yᵢ=1, otherwise yᵢ=0, pᵢ represents a probability value of being predicted as the target category, loss represents the loss function, and α₂ represents a weight parameter.

8. A multi-modal compound eye perception device for a complex degraded environment, configured to implement the multi-modal compound eye perception method for a complex degraded environment according to claim 1, comprising:
an acquisition module, configured to acquire multiple sets of images in the complex degraded environment through a multi-modal compound eye acquisition device, wherein each set of images in the multiple sets of images comprise a visible light image and an infrared image;
an extraction module, configured to input the multiple sets of images into a trained feature point prediction model to extract key feature point information in the visible light images and key feature point information in the infrared images;
a stitching module, configured to generate a visible light stitched image and an infrared stitched image according to a nearest neighbor matching technique, the key feature point information in the visible light images and the key feature point information in the infrared images; and
an output module, configured to input the visible light stitched image and the infrared stitched image into a constructed multi-modal perception detection network to perform target detection to obtain a multi-modal perception detection result.

9. A multi-modal compound eye perception device, comprising:
a processor; and
a memory having computer-readable instructions stored thereon, wherein when the computer-readable instructions are executed by the processor, the method according to claim 1 is implemented.

10. A computer-readable storage medium, wherein program codes are stored in the computer-readable storage medium, and the program codes can be called by a processor to execute the method according to claim 1.

11. The multi-modal compound eye perception device for a complex degraded environment according to claim 8, wherein the extraction model is further configured to:
acquire a visible light sample image;
perform three convolution operations on the visible light sample image to obtain a first convolution feature map, a second convolution feature map, and a third convolution feature map, respectively;
perform a deconvolution operation on the first convolution feature map, the second convolution feature map, and the third convolution feature map respectively, to obtain a first deconvolution image, a second deconvolution image, and a third deconvolution image;
perform feature fusion on the first deconvolution image, the second deconvolution image, and the third deconvolution image to obtain a fused feature map;
input the fused feature map into the maximum pooling layer to obtain a maximum pooling layer output;
input the maximum pooling layer output into a bilinear interpolation layer to obtain a bilinear interpolation layer output;
input the bilinear interpolation layer output into a fully connected layer to obtain key feature point information in the visible light sample image; and
train the feature point prediction model according to the key feature point information in the visible light sample image to obtain the trained feature point prediction model.

12. The multi-modal compound eye perception device for a complex degraded environment according to claim 8, wherein the stitching module is further configured to:
acquire feature points of adjacent visible light images, and match the acquired feature points using the nearest neighbor matching technique to obtain a plurality of matched visible light image feature points;
acquire feature points of adjacent infrared images, and match the acquired feature points using the nearest neighbor matching technique to obtain a plurality of matched infrared image feature points;
establish a constraint condition according to the plurality of matched visible light image feature points;
perform homography transformation alignment on the visible light images and the infrared images respectively according to the constraint condition, the plurality of matched visible light image feature points, and the plurality of matched infrared image feature points, to obtain aligned visible light images and aligned infrared images; and
respectively stitch the aligned visible light images and the aligned infrared images to obtain a visible light stitched image and an infrared stitched image.

13. The multi-modal compound eye perception device for a complex degraded environment according to claim 12, wherein the constraint condition is as shown in a following formula (1):
$${p}_{bi} = {Hp}_{a i} \qquad ( 1 )$$
wherein
$$( \begin{matrix}{x}_{bi} \\ {y}_{bi} \\ 1\end{matrix} ) = ( \begin{matrix}{h}_{11} & {h}_{12} & {h}_{13} \\ {h}_{21} & {h}_{22} & {h}_{23} \\ {h}_{31} & {h}_{32} & 1\end{matrix} ) ( \begin{matrix}{x}_{ai} \\ {y}_{ai} \\ 1\end{matrix} ) \qquad ( 2 )$$
in the formula, p_{bi} and pₐᵢ represent feature points of two adjacent visible light images a and b, H represents a homography transformation matrix, x_{bi} represents an abscissa of an i-th feature point in the image b corresponding to the image a, y_{bi} represents an ordinate of the i-th feature point in the image b corresponding to the image a, h₁₁, h₁₂, h₁₃, h₂₁, h₂₂, h₂₃, h₃₁, and h₃₂ represent parameters in the homography transformation matrix obtained by solving, xₐᵢ represents an abscissa of an i-th feature point in the image a corresponding to the image b, and yₐᵢ represents an ordinate of the i-th feature point in the image a corresponding to the image b.

14. The multi-modal compound eye perception device for a complex degraded environment according to claim 12, wherein a stitching process is as shown in a following formula (3):
$$V = {\sum }_{i = 1}^{n - 1} {α}_{1} {I}_{i}^{ν} + ( 1 - {α}_{1} ) {I}_{i + 1}^{ν} \qquad ( 3 )$$
wherein
$${α}_{1} ( x , y ) = \frac{x - {x}_{1}}{{x}_{2} - {x}_{1}} \qquad ( 4 )$$
in the formular, V represents a stitched image, n represents number of sets of images, α₁ represents a weight factor of the stitching process,
$${I}_{i}^{v}$$
represents an i-th set of visible light images, (x,y) represents a pixel position in an overlapping area, x₁ represents a left boundary of the overlapping area, and x₂ represents a right boundary of the overlapping area.

15. The multi-modal compound eye perception device for a complex degraded environment according to claim 8, wherein the output module is further configured to:
acquire a visible light stitched sample image and an infrared stitched sample image;
perform feature map extraction on the visible light stitched sample image and the infrared stitched sample image through MobileNet, to obtain a visible light feature map and an infrared feature map;
add numbers of channels of the visible light feature map and the infrared feature map to generate an added feature map, and respectively inputting the added feature map into three convolutional layers which are in jump connection to obtain a first feature map, a second feature map, and a third feature map;
perform a convolution operation on the first feature map, the second feature map, and the third feature map respectively, to obtain a first dimensionality reduction result, a second dimensionality reduction result, and a third dimensionality reduction result;
obtain a predicted target position and target category according to the first dimensionality reduction result, the second dimensionality reduction result, and the third dimensionality reduction result;
construct a loss function according to the predicted target position and target category, and training the multi-modal perception detection network according to the loss function to obtain the constructed multimodal perception detection network.

16. The multi-modal compound eye perception device for a complex degraded environment according to claim 15, wherein the loss function is as shown in following formulas (5)-(8):
$${f}_{L 1} ( {P}_{p} , {P}_{l} ) = \{ \begin{matrix}0.5 \times {( {P}_{p} - {P}_{l} )}^{2} , & if \vert {P}_{p} - {P}_{l} \vert < 1 \\ \vert {P}_{p} - {P}_{l} \vert - 0.5 , & other\end{matrix} \qquad ( 5 )$$
$${loss}_{box} = {f}_{L 1} ( {x}_{p} , {x}_{l} ) + {f}_{L 1} ( {y}_{p} , {y}_{l} ) + {f}_{L 1} ( {w}_{p} , {w}_{l} ) + {f}_{L 1} ( {h}_{p} , {h}_{l} ) \qquad ( 6 )$$
$${loss}_{class} = - {\sum }_{i = 1}^{K} {y}_{i} log ( {p}_{i} ) \qquad ( 7 )$$
$$loss = {α}_{2} \times {loss}_{box} + ( 1 - {α}_{2} ) \times {loss}_{class} \qquad ( 8 )$$
in the formulas, f_{L1}(Pₚ, Pₗ) represents a calculation formula of the loss function, Pₚ represents a predicted value, Pₗ represents a true value, loss_{box} represents a loss value of a target bounding box, f_{L1}(xₚ, x₁) represents a loss value of an abscissa of a center point, xₚ represents an abscissa of a predicted target position of the center point, xₗ represents an abscissa of a true target position of the center point, f_{L1}(yₚ, yₗ) represents a loss value of an ordinate of the center point, yₚ represents an ordinate of a predicted target position of the center point, yₗ represents an ordinate of a target position of the center point, f_{L1}(wₚ, wₗ) represents a loss value of a width of the target bounding box, wₚ represents a predicted width of the target bounding box, wₗ represents a true width of the target bounding box, f_{L1}(hₚ, hₗ) represents a loss value of a height of the target bounding box, hₚ represents a predicted height of the target bounding box, hₗ represents a true height of the target bounding box, loss_{class} represents a loss value of the target category information, K represents number of target types, wherein if a target category is correct, yᵢ=1, otherwise yᵢ=0, pᵢ represents a probability value of being predicted as the target category, loss represents the loss function, and on represents a weight parameter.
